(19) United States
(12) Patent Application Publication
(10) Pub. No.: US 2014/0067360 A1
(43) Pub. Date: Mar. 6, 2014

(54) System And Method For On-Demand Simulation Based Learning For Automation Framework

(71) Applicants: Anuradha Bhamidipaty, Bangalore (IN); Suman K. Pathapati, Hyderabad (IN); Mitesh H. Vasa, Bangalore (IN); Anubha Verma, Bangalore (IN)

(72) Inventors: Anuradha Bhamidipaty, Bangalore (IN); Suman K. Pathapati, Hyderabad (IN); Mitesh H. Vasa, Bangalore (IN); Anubha Verma, Bangalore (IN)

(73) Assignee: INTERNATIONAL BUSINESS MACHINES CORPORATION, Armonk, NY (US)

(21) Appl. No.: 13/604,846

(22) Filed: Sep. 6, 2012

(51) Int. Cl. G06F 9/44

(52) U.S. Cl. 703/22

(57) ABSTRACT

Systems and methods for on-demand simulation based learning for an automation framework. According to one embodiment, the system or method comprises an automated process in a real computing environment that encounters a novel, divergent, or defined state that the automation cannot handle. The state is replicated in a simulated computing environment which a user interacts with to resolve the simulated issue. The user's actions are captured and replicated in the real computing environment in order to resolve the issue. Optionally, the user's actions are analyzed and added to the automation database or rules.

### BACKGROUND

The present specification relates to automation, and, more specifically, to systems and methods for the integration of automated and non-automated tasks.

### DESCRIPTION OF THE RELATED ART

In general, automation requires a well-defined state space and well-defined set of inputs to transition from one state to another. In most real-world applications and domains this state space is not well-defined or finite. Since discovering this stable state space can be prohibitively costly or occasionally impossible, automation is usually limited to the portion of the state space that is very well-defined. As a result, any significantly complex set of processes is not completely automatable. The subset of these processes that cannot be automated can only be accomplished by human intervention.

The disconnect between automated and human tasks means that when a human is brought into the loop to perform a task his or her situational awareness—that is, his or her context of the environment in which the task is to be performed—is often incomplete or incorrect. In an ideal setting involving automated and human performed tasks, the transition from automation to human performance should be seamless. To achieve this, the situational awareness of the humans in the loop should be high. This requires the human to be immersed in an environment that provides him the required context to solve a problem.

Accordingly, there is a continued need for a method and system for the integration of automated and non-automated tasks, including a method and system for on-demand simulation based learning for an automation framework.

### SUMMARY OF THE INVENTION

Embodiments of the present invention comprise systems and methods for on-demand simulation based learning for an automation framework. According to one embodiment, a method comprises the steps of: (i) performing an automated process in a real computing environment; (ii) monitoring the performance of the automated process; (iii) halting the automated process if said automated process encounters a state that cannot be processed; (iv) creating a simulated computing environment, wherein the created simulated computing environment comprises the state that said automated process could not process; (v) presenting the simulated computing environment to a user, wherein said user provides an input to the created simulated computing environment; (vi) recording the user's input into the simulated computing environment; and (vii) replicating the user's input in the real computing environment.

Yet another embodiment comprises a method for on-demand simulation based learning for an automation framework, the method comprising the steps of i) performing an automated process in a real computing environment; (ii) monitoring the performance of the automated process; (iii) halting the automated process if said automated process encounters a state that cannot be processed; (iv) creating a simulated computing environment, wherein the created simulated computing environment comprises the state that said automated process could not process; (v) presenting the simulated computing environment to a user, wherein said user provides an input to the created simulated computing environment; (vi) recording the user's input into the simulated computing environment; (vii) replicating the user's input in the real computing environment; and (viii) extracting an automation workflow from the user's input into the simulated computing environment.

In another implementation of the present invention, a non-transitory computer-readable storage medium comprises: (i) program code for performing an automated process in a real computing environment; (ii) program code for monitoring the performance of the automated process; (iii) program code for halting the automated process if said automated process encounters a state that cannot be processed; (iv) program code for creating a simulated computing environment, wherein the created simulated computing environment comprises the state that said automated process could not process; (v) program code for presenting the simulated computing environment to a user, wherein said user provides an input to the created simulated computing environment; (vi) program code for recording the user's input into the simulated computing environment; and (vii) program code for replicating the user's input in the real computing environment. The non-transitory computer-readable storage medium can further comprise: (viii) program code for extracting an automation workflow from the user's input into the simulated computing environment; (ix) program code for presenting a history of states, inputs, and state transitions to the user; (x) program code for observing all possible system descriptors; and/or (xi) program code for filtering those system descriptors that are not relevant to a state or a state transition.

In another implementation, a system for use with an automation framework includes: (i) a real computing environment; (ii) a local database; (iii) a user interface; (iv) a simulated computing environment; and (v) a controller, wherein said controller performs an automated process in the real computing environment and halts the automated process if said automated process encounters a state that cannot be processed, at which point said controller creates and presents to a user a simulated computing environment, and further wherein said controller receives the user's input into the simulated computing environment and replicates the user's input in the real computing environment.

The details of one or more embodiments are described below and in the accompanying drawings. Other objects and advantages of the present invention will in part be obvious, and in part appear hereinafter.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic representation of a method and system for on-demand simulation based learning for an automation framework according to one embodiment;

FIG. 2 is a flowchart of a method for on-demand simulation based learning for an automation framework according to one embodiment; and

FIG. 3 is a schematic representation of a system for on-demand simulation based learning for an automation framework according to one embodiment.

### DETAILED DESCRIPTION

According to one embodiment, for an automated process (or set of processes) in a computing environment the relevant state space is well defined. During the performance of these processes, if a process encounters a state that is novel, divergent, and/or defined which automation cannot or should not handle, automation is stopped. A human is approached but instead of being brought into the loop through text-based alerts alone, he is prompted with a simulated computing environment that simulates the set of inputs and state transitions that led to the novel, divergent, or defined state. This simulated environment captures the human inputs and observes the steps taken to guide the system back to a valid state, at which point automation can take over. The actions that the human performed in the simulated environment are replicated in the real environment in order to attempt to resolve the original problem and continue with automation. The actions that the human in the loop performed are then analyzed and an automation solution is extracted and the automation model is updated.

The state may be, for example, a system descriptor such as a system variable, system file, memory and hard disk snapshot, device handle, or other system specific variable configuration. The user input can be received, for example, from a command-line interface or GUI.

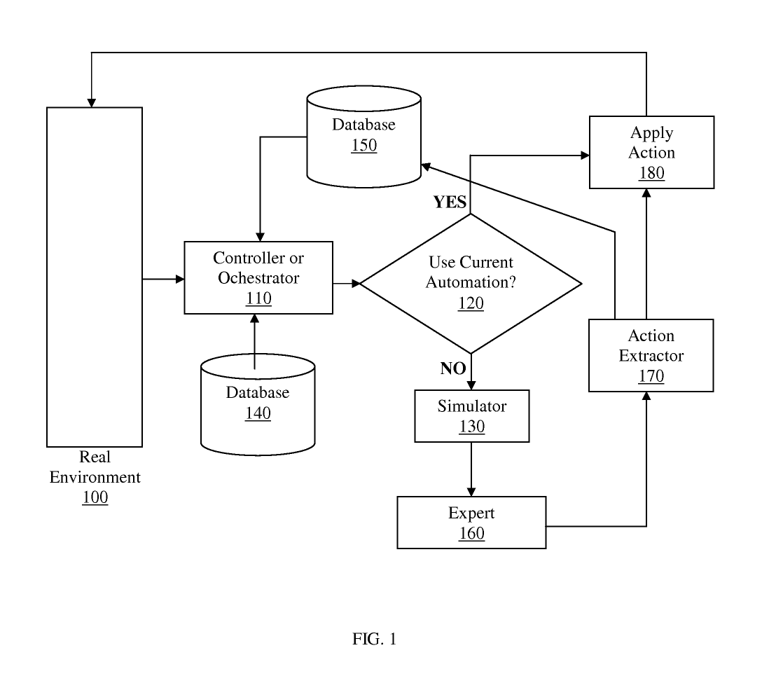

Referring now to the drawings, wherein like reference numerals refer to like parts throughout, there is seen in FIG. 1 a schematic of a method or system for on-demand simulation based learning for an automation framework according to one embodiment. A process or set of processes is initiated in a real computing environment 100 comprising a well-defined state space. During performance, situations are posed to the Controller (or Orchestrator) 110, which utilizes the system's policy and/or rules for automation in certain situations which are stored in database 140, and the automation availability information stored in the automation database 150. At decision point 120, Controller 110 decides whether to use the current automation for the posed situation. If yes, the system or method applies the chosen action at 180, and returns to the next step, process, or situation in real computing environment 100. However, if during the performance of these processes a state that is novel, divergent, and/or defined is encountered which automation cannot (or should not based on defined rules) handle, automation is stopped. Accordingly, the system or method progresses through the “NO” route following decision point 120. A simulated computer environment 130 is established or called up which simulates the set of inputs and state transitions that led to the novel, divergent, and/or defined state. The user or expert 160 is then prompted with the simulated computing environment, and the system or method captures the human inputs into the simulated environment and observes the steps taken to guide the system back to a valid state with Action Extractor 170, at which point automation can take over. The one or more actions that the user performed in the simulated environment are replicated in the real environment at Apply Action 180 in order to attempt to resolve the original problem and continue with automation. Optionally, the actions that the user performed in the simulated computer environment can be analyzed, an automation solution can be extracted, and the automation model is updated.

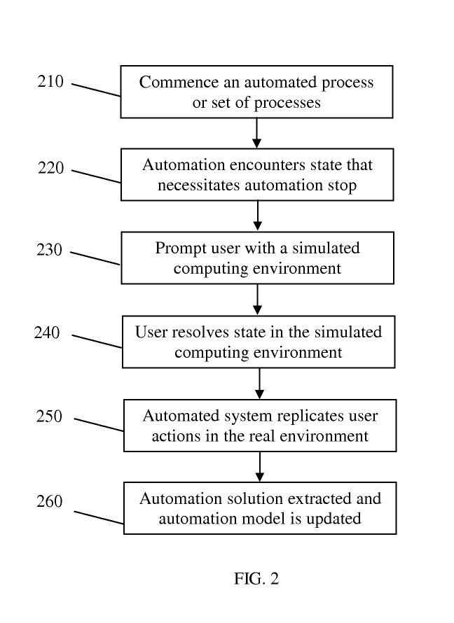

FIG. 2 depicts a flowchart of a method for on-demand simulation based learning for an automation framework according to one embodiment. At step 210, an automated process or set of processes is initiated in a real computing environment comprising a well-defined state space. At step 220, one or more of the automated processes encounters a state that is novel, divergent, and/or defined, and for which automation cannot or should not handle, and automation is stopped. The user can be alerted to the automation stop and the necessity for intervention. At step 230, the user is prompted with a simulated computing environment that simulates the set of inputs and state transitions that led to the novel, divergent, or defined state. At step 240, the user interacts with the simulated computing environment in order to fix, avoid, circumvent, define, or otherwise resolve the novel, divergent, or defined state. The simulated computing environment captures the user input(s) and observes the step(s) taken to guide the system back to a valid state. At step 250, the automated system replicates the user inputs/steps in the real computing environment in order to attempt to resolve the original problem and continue with automation. As an optional step or series of steps 260, the actions/steps that the user performed can then be analyzed and an automation solution can be extracted and the automation model can be updated such that the novel, divergent, or defined state that previously necessitated user intervention will not require intervention when encountered subsequently.

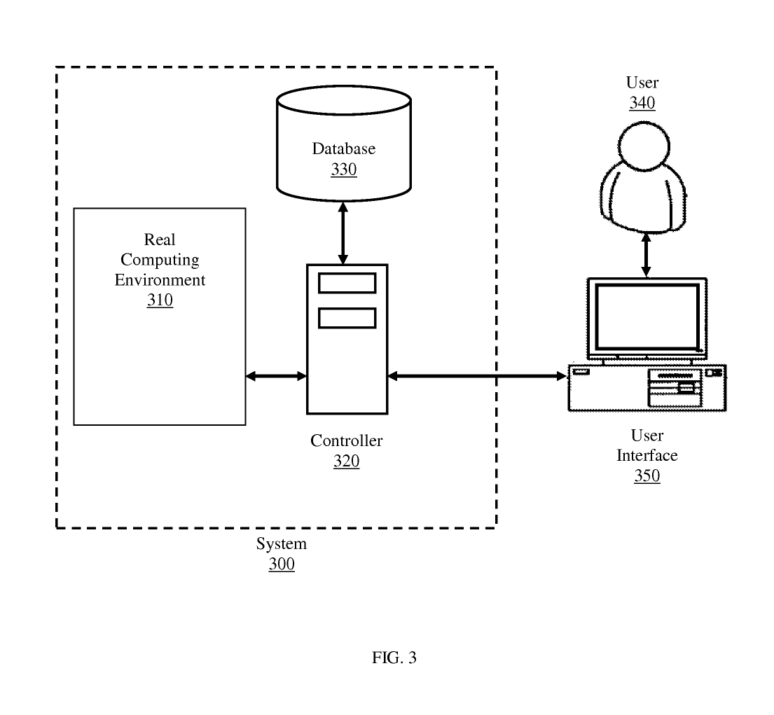

FIG. 3 depicts a schematic representation of a system for on-demand simulation based learning for an automation framework according to one embodiment. A process or set of processes is initiated in a real computing environment 310 comprising a well-defined state space, which may or may not be part of the Controller 320. During performance, situations are posed to Controller 320, which utilizes the system's policy and/or rules for automation in certain situations which are stored in a database such as Database 330, as well as the automation availability information stored in a database such as Database 330. The process or set or processes continue to perform until one or more of these processes encounter a state that is novel, divergent, and/or defined is encountered which automation cannot (or should not based on defined rules) handle, automation is stopped. A simulated computer environment is established or called up which simulates the set of inputs and state transitions that led to the novel, divergent, and/or defined state. The user 340 is then prompted with the simulated computing environment, and the system or method captures the human inputs into the simulated environment via User Interface 350 and observes the steps taken to guide the system back to a valid state with, at which point automation can take over. The one or more actions that the user performed in the simulated environment are replicated in the real environment in order to attempt to resolve the original problem and continue with automation. Optionally, the actions that the user performed in the simulated computer environment can be analyzed, an automation solution can be extracted, and the automation model is updated.

According to one embodiment, the method or system captures user actions and extracts automation action sequences from them, which can be done using existing solutions. Complex simulators can be built which have a front-end behavior consistent with the actual machine. These can even have only basic back-end implementation. Nevertheless, a simplistic realization of the solution can be implemented using a virtual machine replica of the original automation target machine. Endpoint machine's snapshots can be generated before the problem resolution and also of the current state (possibly after some partial solution has been applied). This would allow for the events to replayed to the user.

According to one embodiment, s_{beginstate} is an initial state from the set S comprising of all well-defined states of a system {s₁, s₂ . . . sₙ}, and sₓ is the computing environment state that is akin to a system snapshot consisting of environment variables, relevant configuration files, libraries, etc. s_{beginstate} triggers an automated process a_{beginstate endstate} from a set of automated processes A comprising of process a_{beginstate endstate} where beginstate and endstate are states in S. Each automated process a_{beginstate endstate} comprises of a set of actions {c₁, c₂ . . . cᵣ} that are performed in order. When each action cₓ is performed the system state transitions.

When a new state is observed at time tₙ that is not present in S and hence doesn't have a relevant automation process or action, automation is paused. A simulated computing environment is created using the system state snapshot for the relevant process at time tₙ₋ₚ If n>0 and n≧p.

In this simulated environment, human sequence of actions {hc₁, hc₂, . . . hcₖ} and their resultant states {hs₁, hs₂, . . . hsₖ} are observed until the system is put back into a valid state in S. The observed actions {hc₁, hc₂, . . . hcₖ} are repeated in the original computing environment confirming that {hs₁, hs₂, . . . hsₖ} are observed and that the system is put back into a valid state in S. Finally a new automation process or sub process consisting of {hc₁, hc₂, . . . hcₖ} and resulting in the state transitions {hs₁, hs₂, . . . hsₖ} is created.

As an example of the method or system, consider the automation of Disk cleanup activity, wherein some files and folders must be deleted to generate free space. While most of the actions may be automated, there will be cases where new actions are needed or where the existing actions may not be sufficient to resolve the problem. In cases where files and folders removed using current actions are not sufficient to resolve disk space problem, the automated actions are replayed to the user and he is allowed to perform one or more resolution actions, all in a simulated environment. The user may possibly remove some more files and folders, thus providing second level actions thereby enhancing the existing automated activity over time. The user may also resort to another set of activities around adding more disk space, which could be part of a new automation activity being learned.

According to a further aspect of the present invention, a computer program product is non-transiently stored on a software storage device. The product comprises code for performing a process or set of processes in a real computing environment. The product further comprises code for determining whether a state is novel, divergent, and/or defined and thus that the automated process or set of processes must be stopped. The product further comprises code for establishing a simulated computer environment which simulates the set of inputs and state transitions that led to the novel, divergent, and/or defined state. The product further comprises code for receiving and analyzing user inputs into the simulated environment required to guide the system back to a valid state with, at which point automation can take over. The product further comprises code for repeating in the real environment the actions that the user performed in the simulated environment, in order to attempt to resolve the original problem and continue with automation.

The methods and systems described herein offer several advantages over current automation systems. For example, one advantage is that a human is not handed control in critical situations where he may be unaware of context, and history; instead, the events are played back to him. The human is not required to do passive monitoring; instead, he will be proactively involved as and when events require. Further, the complex last (20% or so) automation that gives diminishing returns can be addressed with reasonable effectiveness. As another advantage, while human involvement allows for handling of critical determined by policy and new problems, at the same time the human's interface is limited to the simulation. Lastly, the human's perspective is constant and easy to understand since he is restricted to interact with a single interface where he will be presented the case at hand.

The methods and systems described herein offer several advantages over completely human-controlled systems. For example, one advantage is that the system or method saves the human the trouble of switching logins and/or using different machines. Further, the simulated environment is a safe environment in that it allows practical capabilities such as a complete undo, and etc. Further, it is easier to capture user input and actions from a simulated environment, which will perform in an optimal manner.

As will be appreciated by one skilled in the art, aspects of the present invention may be embodied as a system, method or computer program product. Accordingly, aspects of the present invention may take the form of an entirely hardware embodiment, an entirely software embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction performance system, apparatus, or device.

The program code may perform entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although the present invention has been described in connection with a preferred embodiment, it should be understood that modifications, alterations, and additions can be made to the invention without departing from the scope of the invention as defined by the claims.

What is claimed is:

1. A method in an automation framework, the method comprising:
performing an automated process in a real computing environment;
monitoring the performance of the automated process;
halting the automated process if said automated process encounters a state that cannot be processed;
creating a simulated computing environment, wherein the created simulated computing environment comprises the state that said automated process could not process;
presenting the simulated computing environment to a user, wherein said user provides an input to the created simulated computing environment;
recording the user's input into the simulated computing environment; and
replicating the user's input in the real computing environment.

2. The method of claim 1, further comprising the step of extracting an automation workflow from the user's input into the simulated computing environment.

3. The method of claim 1, wherein the state may include a system descriptor.

4. The method of claim 1, wherein the state does not exist or does not have any transition to an automation workflow in the automation framework.

5. The method of claim 2, wherein the state is an error state that was not expected in the context of an existing automation workflow instance.

6. The method of claim 1, further comprising the step of presenting a history of states, inputs, and state transitions to the user.

7. The method of claim 1, wherein said user input is received from a command-line interface or GUI.

8. The method of claim 1, further comprising the steps of
observing all possible system descriptors; and
filtering those system descriptors that are not relevant to a state or a state transition.

9. The method of claim 2, wherein the automation workflow comprises an action or command, the associated states and system descriptors, and the state transitions.

10. The method of claim 2, wherein said extracting step comprises analyzing user input from more than one simulated computing environment.

11. The method of claim 2, wherein said extracting step comprises identifying the best automation workflow based on specified constraining criteria.

12. A non-transitory computer-readable storage medium containing program code comprising:
program code for performing an automated process in a real computing environment;
program code for monitoring the performance of the automated process;
program code for halting the automated process if said automated process encounters a state that cannot be processed;
program code for creating a simulated computing environment, wherein the created simulated computing environment comprises the state that said automated process could not process;
program code for presenting the simulated computing environment to a user, wherein said user provides an input to the created simulated computing environment;
program code for recording the user's input into the simulated computing environment; and
program code for replicating the user's input in the real computing environment.

13. The computer-readable storage medium of claim 12, further comprising program code for extracting an automation workflow from the user's input into the simulated computing environment.

14. The computer-readable storage medium of claim 12, further comprising program code for presenting a history of states, inputs, and state transitions to the user.

15. The computer-readable storage medium of claim 12, wherein said user input is received from a command-line interface or GUI.

16. The computer-readable storage medium of claim 1, further comprising:
program code for observing all possible system descriptors; and
program code for filtering those system descriptors that are not relevant to a state or a state transition.

17. A system for use with an automation framework, the system comprising:
a real computing environment;
a local database;
a user interface;
a simulated computing environment;
a controller, wherein said controller performs an automated process in the real computing environment and halts the automated process if said automated process encounters a state that cannot be processed, at which point said controller creates and presents to a user a simulated computing environment, and further wherein said controller receives the user's input into the simulated computing environment and replicates the user's input in the real computing environment.

18. The system of claim 17, wherein said controller extracts an automation workflow from the user's input into the simulated computing environment.

19. The system of claim 17, wherein said user interface is a command-line interface or GUI.

20. The system of claim 17, wherein the automation workflow comprises an action or command, the associated states and system descriptors, and the state transitions.
